(19) United States
(12) Patent Application Publication
(10) Pub. No.: US 2011/0265634 A1
(43) Pub. Date: Nov. 3, 2011

(54) Guitar Speaker Drum and Rack System

(76) Inventor: Joseph Licalzi, Land O Lakes, FL (US)

(21) Appl. No.: 13/027,222

(22) Filed: Feb. 14, 2011

Related U.S. Application Data
(60) Provisional application No. 61/330,277, filed on Apr. 30, 2010.

(51) Int. Cl. G10H 3/00

(52) U.S. Cl. 84/723

(57) ABSTRACT

A drum, tube or cylinder of any size using any speaker that can be mounted using any standard drum lugs. Covered either using vinyl, leather, fur, metal, plastic and or wood grain painted or stained. With the speakers in the drums, the sound waves can be deadened so the microphone can only pick up speaker roll off or the sound waves coming off of the speaker, with no corners. There is no place for wind to go, so extra wind can not get pushed back onto the cone resulting in mud or cancel, where the speaker is pushed to the side, using the soft pillow to adjust the airflow you can deaden any amount of airflow inside the drum. A typical cabinet open or closed has to much room for extra air so the use of multiple amps will push more air onto the speaker cone.

### BACKGROUND OF THE INVENTION

Guitar speaker drum was designed to separate two combined guitar or bass speakers into two separate guitar or bass speakers. In separating the speakers and redesign of the speaker housing, the left microphone would no longer pick up the sound from the right speaker and vice versa. The elongated and open-end design of the drum allows the sound waves to compress and decompress naturally. The usual square speaker boxes are enclosed restricting the air flow which would result in unwanted noise or the music term which is referred to as “mud”. I insulated the drum walls with optional foam padding and a hairy fabric to deaden all sound waves of the compressed side of the speaker cone, this also helps to eliminate “Mud” and you get more sustain from the voice coil. I also provided a drum cover to be removed when in use in standard square boxes the speakers are covered with tolex and puts limits on the microphone, the speaker drum allows microphone to be placed 1 millimeter away from speaker cone. The drum rack is a commercially available standard drum rack or light stand fabricated or customized to hold any guitar or bass guitar head and the speaker drums by a shelf or tubing made of wood, metal, plastic or fiberglass.

### CROSS REFERENCE TO RELATED APPLICATIONS:

U.S. Pat. No. 4,756,382 Hudson Filed March 1987

U.S. Pat. No. 5,191,177 Chi Filed July 1991

U.S. Pat. No. 7,657,051 Kahoe Filed May 2006

Des 392,640 Tully/Jordan Filed November 1996

U.S. Pat. No. 7,560,632 Lanzel/Torgerson Filed November 2006

D613,092 S Eason/Nakajima Filed November 2007

U.S. Pat. No. 5,293,000 Adisolfi Filed August 1992

U.S. Pat. No. 5,430,245 Rogers Filed October 1993

U.S. Pat. No. 6,982,376 B2 Wise Filed October 2003

U.S. Pat. No. 7,282,633 B1 Coolidge Filed March 2005

US2007/0189553 A1 Holden Filed February 2006

### SUMMARY OF THE INVENTION

The guitar speaker drum is a cylinder that varies from 8-18 inches in diameter size. Depending on the size of the guitar, bass or subwoofer speaker it is housing. It can range anywhere from 12 to 48 inches (or more) in length. The first reason for the drum was to separate the speakers from the traditional square box that held two speakers or four speakers. By separating the speakers you can hear the guitar or bass guitar in true stereo and eliminate phasing. Phasing is caused by placing the left and right speaker right next to each other in a square box. Phasing is only heard by a microphone and it occurs when the left microphone is picking up the bass response from the right speaker, and the right microphone is picking up the bass response from the left speaker. This is how we came up with the idea to separate the speakers. The drums can be mounted on commercially available Dejembe stands or Tom Tom legs and mounts, then mounted on tubing. The guitar head will rest on a shelf or tubing that is Supported by a commercially available standard drum rack or light stand with some fabrication. The drum cover is to provide protection to the speaker when not in use, when the drum is in use the cover is removed or mounted on back of speaker drum to seal rear of drum. Also inside the speaker drum is a soft hairy pillow that lets you adjust the airflow the full length of speaker drum.

### DESCRIPTION OF THE DRAWING

FIG. 1: is a side inside view, partially cut-away of the guitar or bass speaker

Drawing is listed as FIG. 1—the number explains which part of the drawing the description is referring to.

FIG. 1:1 clamp or claw with compression to hold or compress drum to rear of speaker frame

FIG. 1:2 a single or double sided drum lug that holds FIG. 1:1 clamp or claw to speaker frame

FIG. 1:3 claw or clamp that is secured to rear of drum lug that will secure FIG. 1:9 tension cable or FIG. 1:9 tension rod

FIG. 1:4 clamp or claw that is secure to FIG. 1:9 tension rod or FIG. 1:9 tension cable and uses the strength of drum to help support the speaker and relieve tension on drum lug

FIG. 1:5 round drum or cylinder ranging in size from 12 inches to 4 feet in length and 8 inches to 18 inches in diameter

FIG. 1:6 ½ or more inch thick foam padding glued to inside of entire length of drum

FIG. 1:7 optional hairy or furry fabric that is glued to the inside of the foam that covers length of the drum

FIG. 1:8 2 inch to 4 inch screw that is mounted to drum lug and secures drum claw to speaker that pulls speaker to drum when tighten

FIG. 1:9 tension cable or tension rod that is tighten with FIG. 1:10 screw and FIG. 1:3 claw to help relieve load off of FIG. 1:2 drum lug

FIG. 1:10 2 inch to 4 inch screw to tighten FIG. 1:9 tension rod or tension cable

FIG. 1:11 musical instrument guitar or bass guitar speaker or subwoofer that is mounted from outside to FIG. 1:5 drum or tube

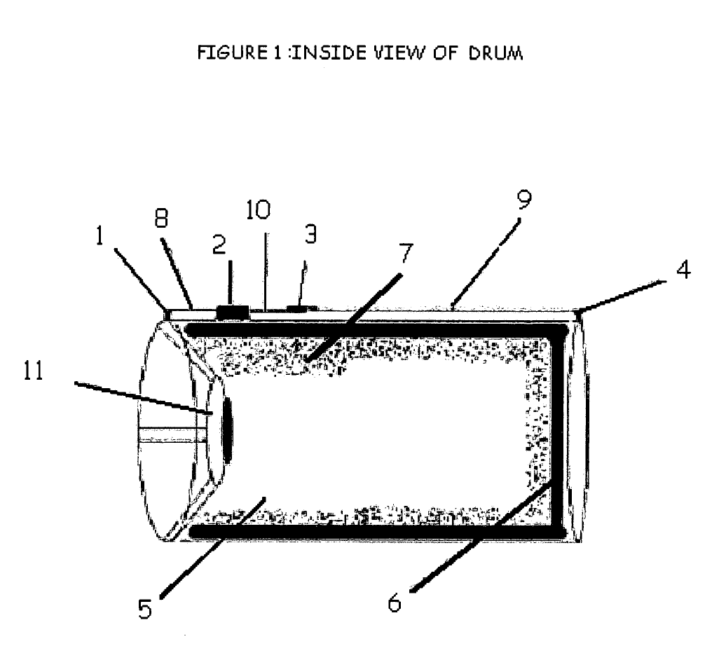

1. Guitar speaker drum was designed to separate two combined guitar or bass speakers into two separate guitar or bass speakers. In separating the speakers and redesign of the speaker housing, the left microphone would no longer pick up the sound from right speaker and vice versa. The elongated and open end design of the drum allows the sound waves to compress and decompress naturally. The usual square speaker boxes are enclosed restricting the air flow which would result in unwanted noise or the music term which is referred to as “mud”. I have insulated the drum walls with foam padding and a hairy fabric to deaden all sound waves of the compressed side of the speaker cone, this also helps to eliminate “Mud” and you get more sustain from the voice coil.
